(19) United States
(12) Patent Application Publication
(10) Pub. No.: US 2008/0275682 A1
(43) Pub. Date: Nov. 6, 2008

(54) Method and system for axle evaluation and tuning with loading system and vehicle model

(76) Inventor: William J. Langer, Minnestrista, MN (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/800,526

(22) Filed: May 4, 2007

(51) Int. Cl. G06G 7/48

(52) U.S. Cl. 703/8

(57) ABSTRACT

A method and system for evaluating and tuning axle systems includes at least one test rig on which one or more physical axle systems are mounted. A full vehicle model and a road description are used with the test rig to test and evaluate or tune the axle system as would be conducted on a real test track. The full vehicle model is modified to remove the characteristics of the axle system under test. The remainder of the full vehicle model produces output signals in the form of displacements or loads that are transmitted as inputs to the test rig to apply those signals. The test rig measures output signals in the form of complementary displacements or loads that will become inputs to the vehicle model in place of the removed model of the axle system under test. In this manner, the physical axle system under test is inserted into a real time model of the full vehicle, road and driver.

### FIELD OF DISCLOSURE

This application generally relates to vehicle axle testing and evaluations, and more specifically, to methods and systems for testing and tuning axles and axle components, and determining their effect on vehicle performance.

### BACKGROUND

Vehicle axles must be evaluated, tested or tuned to meet desired vehicle-level performance attributes such as ride, comfort, NVH (noise, harshness, vibration), etc. Today, in order to assess vehicle-level attributes, the vehicle must be driven with the real components installed. This method is costly, slow, and non-repeatable. Also, such driving tests typically occur late in the vehicle development process. Further, engineers might assess the impact of a vehicle to an axle to assess attributes such as performance, durability, NVH, etc.

A suspension controls the attitude and position of the sprung mass and also isolates the sprung mass from road irregularities. An axle provides the functions of a suspension plus steering, braking, driving torque, directional control and stability of the vehicle. Axle components may include some or all of the following, as well as others not listed: dampers, struts, springs, bushings, linkages, sub-frame, steering system, stabilizer bars/mechanisms, brake systems, power train components (including motors), tires and wheels. Any of these components may be active or passive. Active systems are those that are controlled by some type of computer based on signals from sensors, although certain active systems may be sensorless, such as vector controlled AC motors that do not use sensors for speed controls.

Axles, which influence vehicle attributes such as ride, comfort and handling, are characterized in testing equipment, but such testing equipment does not directly relate to, or measure, the vehicle response to the given component. Current testing equipment characterizes axles by applying a load or a displacement time history to the axle and measuring resultant load or displacements. To demonstrate the challenge, two different axles, with different in-vehicle performance, might yield the same characterization data when evaluated in conventional test equipment.

In the case of a real vehicle on a test track, the evaluation of axle effects on vehicle performance can be directly observed and measured. The measurement of vehicle performance then depends only on the ability to measure the necessary effects and the repeatability of the test track process. However, in the case of laboratory test rig evaluation of axle performance, either measured time histories or idealized time histories are applied to the axle only. The resulting axle loads or displacements are reduced to engineering terms such as parameter maps, gradients or frequency response functions. The reduced engineering terms of axle performance are used to deduce resultant vehicle behavior through a vehicle model or expert interpretation that is applied after the test results are obtained. While track testing provides complete vehicle-level responses, by definition, it requires a complete vehicle and also brings other practical penalties such as vehicle availability, weather and repeatability limitations, and the time-intensive process of damper change-outs.

A limitation in the laboratory test rig evaluation process is that a simplified model is assumed for the axle or axle component. This means that it is possible to use a model that ignores important axle or component characteristics. This is especially true for those characteristics that may manifest during a transient or dynamic input, be sensitive to temperature or humidity, or be subject to non-linear effects such as friction. Further, the process does not capture changing axle or axle component characteristics. An axle that has characteristics that change depending on recent history or hard-to-model parameters such as temperature or friction will not develop or be measured on a laboratory test rig in a manner that accurately predicts vehicle behavior.

Therefore, there is a need to provide an axle/axle component development, evaluation, validation, and tuning process and system that does not rely on a simplified model of an axle/component or a full vehicle. Further, there is a need in such a system to capture changing axle/component characteristics and translate the results to vehicle-level attributes.

Further, there is a need to assess the effects of a vehicle on a component without the need for an actual vehicle. In such an evaluation, the component would be exposed to realistic vehicle-based inputs, as if in service, to assess the component for durability, NVH, or other attributes. The realistic vehicle/driver inputs could replace the simplified engineering inputs (e.g., sine waves) common in traditional test rig based methods.

### SUMMARY

This and other needs are met by embodiments of the present invention, which provide a system for evaluating axles that comprise a test rig on which at least one axle component is mountable, and a vehicle model module. The test rig controllably applies loads on the axle component under test. The vehicle model module includes a data processor for processing data, and a data storage device. The data storage device is configured to store: data related to a vehicle model that simulates a full vehicle except for characteristics of the axle component under test; data related to a road description; driving instructions, human driver control and machine-executable instructions. Upon execution by the data processor, the instructions control the data processor to produce command signals based on the vehicle model to control the test rig to apply loads on the axle component and to feed back measured responses of the test rig to the vehicle model.

The foregoing and other features, aspects and advantages of the disclosed embodiments will become more apparent from the following detailed description and accompanying drawings.

### BRIEF DESCRIPTION OF THE DRAWINGS

The present disclosure is illustrated by way of example and not by way of limitation, in the figures of the accompanying drawings and in which like reference numerals refer to similar elements.

FIG. 1 depicts a partially perspective, partially block view of a system for axle evaluation constructed in accordance with certain embodiments of the present invention.

FIG. 2 is a block diagram of the system of FIG. 1, depicting the relationships between components of the system in more detail.

FIG. 3 is a front view of the test rig depicted in FIG. 1, constructed in accordance with embodiments of the present invention.

FIG. 4 is a plan view of a portion of the test rig of FIG. 3.

FIG. 5 is a block diagram of a data processor system useable in embodiments of the present invention.

### DETAILED DESCRIPTION

For illustration purposes, the following descriptions describe various illustrative embodiments of simulation systems for evaluating or tuning an axle or axle component. Specific systems and configurations of the test rig are depicted. It will be apparent, however, to one skilled in the art that concepts of the disclosure may be practiced or implemented without these specific details. In other instances, well-known structures and devices are shown in block diagram form in order to avoid unnecessarily obscuring the present disclosure. Also, for ease of description, the terms “axle” and “axle component” will be employed interchangeably throughout, instead of the term “axle/components”. However, it should be understood that for purposes of this description, the embodiments of the invention are applicable to testing and evaluating an entire axle system, or only one or more components of the axle system. Hence, in the following description, the test methodology and testing apparatus may include multiple axles. A test rig can be provided that is configured for multiple axles, or a separate test rig can be provided for each axle. Therefore, it should be understood throughout this description that the use of the term “axle” may include a single axle or multiple axles.

Embodiments of the present invention address and solve problems related to the process of axle testing, characterization, evaluation, model validation, or tuning. For ease of description, the term “evaluation” will be employed to refer to the process of testing, characterization, evaluation, model validation or tuning. These problems are solved, at least in part, by embodiments of the present invention that provide a system for evaluating axles that comprise at least one test rig on which at least one axle component is mountable, and a vehicle model module. The test rig controllably applies loads on the axle component under test. The vehicle model module includes a data processor for processing data, and a data storage device. The data storage device is configured to store: data related to a vehicle model that simulates a full vehicle except for characteristics of the axle component present under test; data related to a road description; and machine-readable instructions. Upon execution by the data processor, the instructions control the data processor to produce command signals based on the vehicle model to control the test rig to apply loads on the axle component and to feed back measured responses of the test rig to the vehicle model.

There are numerous potential benefits achieved with embodiments of the present invention. These include allowing axle testing to occur without the need to gather road data with a full vehicle. This permits earlier testing in the design process than otherwise possible.

Another benefit of the disclosed embodiments is that the test process need not reduce the axle characteristics to simplified engineering terms of an implied axle model. This is because the real axle(s), with all of its un-modeled characteristics, interacts with the modeled vehicle as it would with a real vehicle. Also, because the axle interacts with the vehicle model through test rig feedbacks, changes in the axle characteristics will result in changes in applied load, as would happen on a real road. This results in more realistic axle evaluation. The effect of the axle system on vehicle behavior is measured directly in the vehicle model, just as the more inconvenient road test measures axle system/vehicle behavior directly.

Further, the effect of the modeled vehicle on the axle system may be observed or measured directly with sensors on the test rig, just as the effect of the more inconvenient road test allows direct observation or measurement of the axle system. It is also possible, with embodiments of the invention, to characterize the axle under conditions which represent those that would occur on the road, without the need for either a real vehicle or a real road, which may not be available at the time of measurement. The resulting characterization can be more representative than prior characterizations based on more traditional synthetic inputs, such as sinusoidal inputs.

A further benefit provided by embodiments include the ability to evaluate vehicle changes on the suspension without having to physically build the vehicle or modify a vehicle with the change to determine the effect on the axle or suspension behavior or the performance of the vehicle with the axle or suspension and vehicle change.

Another benefit is that time consuming load history iteration compensations are rendered unnecessary by certain embodiments of the invention due to minimum tracking error characteristics of the test rig. Also, the set of all possible axles can be reduced to a smaller set for in-vehicle analysis reducing track testing cost and time.

A still further benefit is the ability to isolate the physical components of the axle system to only those which are of interest for the test. This is, of course, not possible for evaluation conducted on the test track where most, if not all, of the vehicle is required in order to conduct tests.

The ability to perform axle evaluation and tuning earlier in the design process avoids late cycle changes and impacts to dependent vehicle characteristics such as NVH, durability, etc. Also, the embodiments of the invention provide the ability to assess axle system design and manufacturing changes on the parameters of the vehicle without needing an actual full vehicle. This allows performance of evaluations, often at an earlier stage and at less cost, of durability, performance, safety, NVH and other evaluations without requiring a full vehicle. The embodiments of the invention also provide the ability to more accurately induce and capture the effects of axle system wear.

An automobile includes various subsystems for performing different functions such as power train, driver interface, climate and entertainment, network and interface, lighting, safety, engine, braking, steering, chassis, etc. Each subsystem further includes components, parts and other subsystems. For instance, a power train subsystem may include a transmission controller, a continuously variable transmission (CVT) control, an automated manual transmission system, a transfer case, an all wheel drive (AWD) system, an electronic stability control system (ESC), a traction control system (TCS), etc. A chassis subsystem may include active or passive dampers, springs, bushings, body control actuators, load leveling, anti-roll bars, etc. Designs and durability of these subsystems need to be tested and verified during the design and manufacturing process. Some of the subsystems use electronic control units (ECU) that actively monitor the driving condition of a vehicle and dynamically adjust the operations and/or characters of the subsystems, to provide better control or comfort. Models used for vehicle evaluation must in some way include all relevant subsystems.

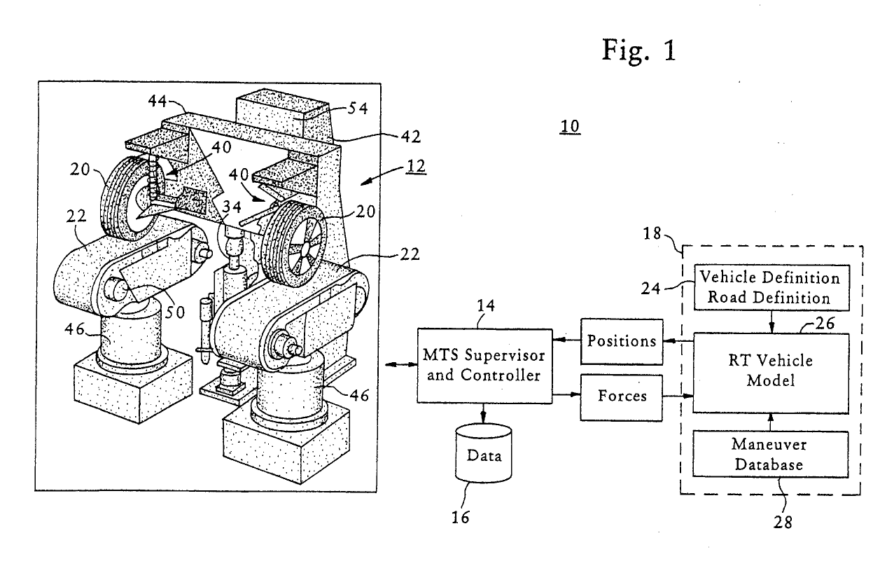

Certain embodiments of the present invention provide methods and systems to perform axle system testing, evaluation or tuning by combining a full vehicle model, a road description and at least one test rig on which is mounted one or more physical axle systems. An exemplary embodiment of such a system 10 is depicted in FIG. 1.

The system 10 includes at least one test rig 12, a supervisor and controller (hereafter “supervisor”) 14, a data storage device 16, and a vehicle model module 18, including environment and maneuver definitions. In certain described exemplary embodiments, the vehicle model module 18 is implemented on a data processor that is separate from the data processor implementing the supervisor 14. In other exemplary embodiments, the supervisor 14 and vehicle model module 18 are realized by a single data processor. In embodiments of the invention, the vehicle model is in the context of vehicle dynamics, and the use of the term “vehicle model” should be understood in that context. This is in contrast to models in other types of contexts, such as a thermal model or a structural analysis model.

The configuration of the test rig 12 depicted in FIG. 1 is exemplary only, as other configurations and types of test rigs may be used without departing from the scope of the invention. The exemplary test rig 12 allows one or more axle components 40 to be mounted for evaluation. In the illustrated example, tires 20 are mounted on the axle components 40 and contact simulated roadway surfaces 22. The axle components 40 are mounted to the test rig 12 in a manner that allows displacements or loads to be applied and resultant displacements or loads to be measured. One or two ends of an axle can be provided, for example. One to N axles can be tested and evaluated.

Among other options, various environmental effects can be simulated. For example, the test rig 12, or axle system 40, may be located in a climate chamber (not shown) to control and/or capture the effects of heat, cold, humidity, moisture, dirt, salt or other environmental factors. Different roadway surface conditions may be simulated. For example, the flat belt 22 may be coated with a material to simulate the coefficient of friction of a real road using properties of the coating such as roughness, texture, etc. Certain methods of testing, according to other embodiments of the invention, apply water, snow, ice, dirt or dust to the flat belt 22 or other roadway surface, to control tire and roadway interactions, including, but not limited to, forces, moments, and thermal loading. In other embodiments, obstacles are affixed to the flat belt 22 to simulate curb or bump strikes. In certain embodiments, curb or bump strikes are applied by an auxiliary device (not shown). For example, an adjacent mechanism can be used to guide a bump between the tire and the roadway so that the bump can be introduced asynchronously with the roadway rotation period. The temperature of the tire 20 is controlled in accordance with certain embodiments of the present invention, to simulate load-based heating of real driving conditions. In such embodiments, the set points can be input from a tire/vehicle model or a data file.

Different environment and road surface conditions may be simulated in software. The road surface can be defined in a software model or measured and translated to software code, in different embodiments of the invention. The road definition can include parameters that are large relative to the tire. The environment simulation may include influences on the vehicle such as wind and air.

The test rig 12 includes a plurality of mounts that control the position and orientation of the tires 20, and the loads applied to the tires. For example, the following control parameters, as well as their translational or rotation equivalents, may be controlled. These include slip angle (steer), inclination angle (camber), loaded radius, normal force, wheel torque, slip ratio, longitudinal force, lateral force, etc. The method induces one or more of the other tire degrees of freedom, such as normal force, slip angle, inclination (camber) angle, slip ratio, wheel torque, loaded radius, inflation pressure, etc. Certain embodiments of the invention also induce one or more of the real degrees of freedom between the road and tire and wheel/spindle and body, through movement of the roadway or the spindle.

Embodiments of the methods of the invention introduce at least one of the following degrees of freedom: tire normal force, tire lateral force, tire steer angle, tire rotation, steer wheel input, body pitch, body roll, and body normal (vertical) force.

Embodiments of the invention control the speed/torque of the roadway 22 and the tires 20 to simulate rotational slip, such as that induced by acceleration over a low coefficient friction surface, based on tire to road surface torque as calculated by the vehicle model module 18. A further ability provided in certain embodiments is to apply simulated spindle braking or accelerating torque-set points from a tire/vehicle model or a data file.

The test rig 12 depicted in FIG. 1 includes a vertically extending stand 42 that supports a positioning plate 44 that is slidable in a vertical direction. The positioning plate 44 carries the axle components 40 so that movement of the positioning plate 44 causes displacements and loading of the axle components 40. One or more loading actuators provide controllable loads and displacements to the axle components 40 through vertical loading of the positioning plate 44. The loading actuators 34 are independently controllable to apply independent vertical loads and/or other linear degrees of freedom. The loading actuators change the height and roll angle of the axle systems 40 by acting on the positioning plate 44.

Depending on the configuration of the physical suspension included in the test, the test rig 12 can provide different degrees of freedom (DOF). Systems can be provided with a single DOF (vertical); two DOF (vertical and roll); three DOF (vertical, roll and lateral); and 4 DOF (vertical, roll, lateral and yaw). A lateral DOF is needed if the lateral axle compliance needs to be simulated. Yaw may be needed if that suspension compliance is not physically present.

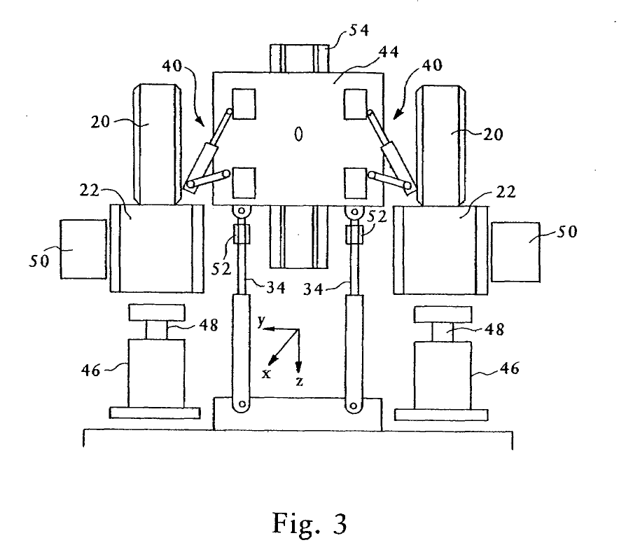

The test rig 12 of FIG. 1 includes a pair of simulated roadway surfaces 22 that are supported by posts 46. In certain embodiments, the posts 46 include vertically moveable supports 48 (FIG. 3) that are also controllably moveable around the vertical axis. In the illustrated embodiment, the simulated roadway surfaces 22 are flat belts 22 that induce tire rotation to provide a simulated roadway. The flat belts 22 are controllably driven by motors 50. Other types of simulated roadways can be used, such as drums, etc. However, a flat roadway surface, such as provided in the illustrated example, creates a more accurate tire contact patch simulation than is possible with a curved surface, such as with a drum-based roadway. Through control of the simulated roadway surfaces 22, certain embodiments of the invention allow inducing braking or accelerating torque to any spindle (tire 20).

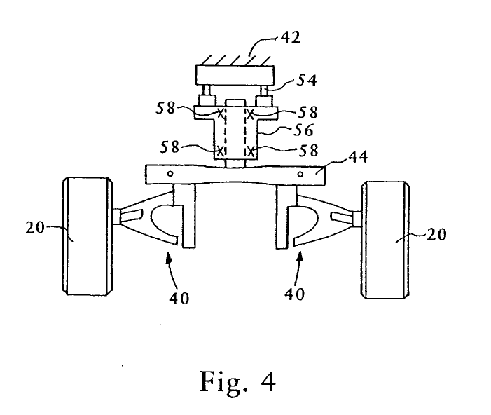

The configuration of the simulated roadway surfaces 22, with posts 46 and pistons 48, allows inputs of three degrees of freedom (road vertical, steer and longitudinal) for each tire 20. Referring to FIGS. 3 and 4, in addition to FIG. 1, load cells 52 are provided at the loading actuators 34 to sense forces and moments. Load cells can also be installed in the roadway 22, in certain embodiments, to measure the forces. In the illustrated embodiment, the load cells 52 will sense the Fz and Mx forces and moments. The sensed measurements are provided to the vehicle model module 18 through the supervisor 14.

In certain embodiments, the test rig 12 is configured such that axles are mounted on opposing sides of a rolling surface. This has the advantage of offsetting axle induced loads on the rolling surface device.

In certain embodiments, the test rig 12 is configured without the tire rotational degree of freedom. In certain embodiments, the test rig 12 is configured to couple with the spindle assembly.

As seen in FIGS. 3 and 4, the positioning plate 44 is mounted on a slide rail 54 that extends vertically on the stand 42. A slide rail coupling 56 couples the positioning plate 44 to the slide rail 54 for vertical movement along the slide rail 54. The positioning plate 44 is coupled to the slide rail coupling 56 in a pivotable manner. Hence, two degrees of freedom (vertical slide and roll pivot) are provided for the positioning plate 44 and the axle components 40.

In the embodiment depicted in FIG. 4, a measuring device 58 is provided at the slide rail coupling 56. The measuring device 58 provides sensed measurements of Fx, Fy, My and Mz in the illustrated embodiment. These sensed measurements are provided as feed back to the vehicle model module 18 through the supervisor 14.

The positioning of the axle components 40 are provided by the vehicle model module 18 to the supervisor 14. In turn, the supervisor 14 issues command signals to the test rig 12 to control the loading actuators 34, the pistons 48 and the simulated roadway surfaces 22 according to the positions provided by the vehicle model module 18. The load cells 52 and measuring device 58 produce signals representing measured forces and moments that are provided back to the vehicle model 26 through the supervisor 14. For example, the embodiments of the invention are able to measure damper responses.

As stated earlier, embodiments of the invention perform axle system testing, characterization, model validation, evaluation or tuning by combining a full vehicle model, a road description and a test rig on which is mounted one or more physical axle system components. To this end, a vehicle definition and road definition 24 are provided as inputs to a vehicle model 26 of the vehicle model module 18. A maneuver database 28 is also provided as an input to the vehicle model 26. Driver maneuvers, time histories, or mathematical functions, are defined to excite required vehicle metrics that are influenced by an axle. In certain embodiments, synthetic inputs are defined to excite required vehicle metrics influenced by an axle.

The output of the vehicle model 26, positions, for example, are to be applied to the axle components 40. The supervisor 14 generates command signals based on this information to control the test rig 12, including, for example, the loading actuators 34 and the movement of the pistons 48. Some of the angles and loads provided by the vehicle model module 18 in the example of FIG. 3 can include: body z, γ, road z(2), road α(2), road v(2), and steer. Some of the forces and moments measured at the test rig 12, provided as inputs to the vehicle model module 18, can include: body FxFyFz, body MxMyMz and axle z(2). The supervisor 14 provides measurements, such as forces and moments, received from the test rig 12 and inputs these into the vehicle model 26. The forces and moments can be measured at the test rig 12 by any suitable devices, such as load cells provided on different axes.

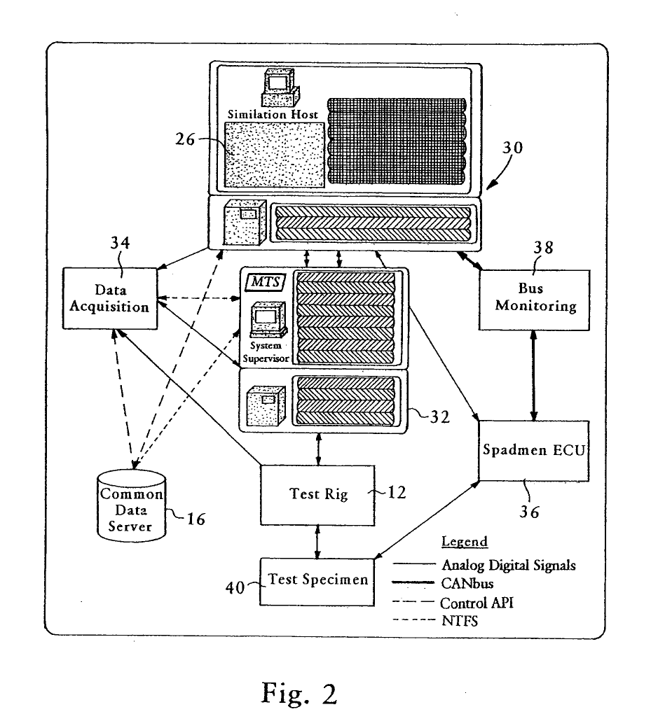

Embodiments of the invention combine a full vehicle model, a road description and a test rig with the physical axle. Modeling techniques are widely used and known to people skilled in the art. Companies supplying tools for building simulation models include Tesis, dSPACE, Mechanical Simulation Corporation, the MathWorks. Companies that provide HIL include dSPACE, ETAS, Opal RT, A&D, etc. The full vehicle model 26 is executed in real time, in certain embodiments, by a separate data processor 30, as seen in FIG. 2. The full vehicle model 26 may include the following vehicle functions executed in real time: engine, powertrain, tires, vehicle dynamics, axles, aerodynamics, driver, road. In certain embodiments, the vehicle model is configured with parameters of a target real vehicle.

As stated earlier, at least one physical axle component is used in the testing, and this axle component is not in the model. Other axle components are modeled if they are not physically present on the test rig 12. Hence, only a single physical axle component may be tested, with the other axle components modeled in the full vehicle model 26. Alternatively, a convergence method is used in certain embodiments to determine axle effects on vehicle performance if other axle components are not physically present based on iterative readings from the axle components 40 that are physically present. The present axle component 40 is swapped by the software to various positions on the virtual vehicle in the full vehicle model 26. Iterative techniques are used to converge on a solution within defined error limits by using the real axle system data or the simulation solution to populate axle system models or determine vehicle response.

The context of the model is one which predicts the motion of the vehicle over the ground, given a driver's input of steering, throttle, brake and gear, as well as external disturbances such as aerodynamic forces. The model can be operated open loop with respect to the driver replicating driver's inputs versus time. The model can be operated closed loop with respect to the driver if the driver's inputs are adjusted to maintain a speed and course of the vehicle.

The full vehicle model 26 is modified, as mentioned earlier, to remove the characteristic of the axle system components under test. The remainder of the full vehicle model 26 is provided with the output signal described above, in the form of displacements or loads, which are transmitted as input signals to the test rig 12 to apply those same signals. The test rig 12 measures output signals in the form of complementary displacements or loads that become physical inputs to the full vehicle model 26 in place of the removed model of the axle component or components under test. In this way, the physical axle system components under test are inserted into a real time model 26 of the full vehicle, road and driver.

Embodiments of the testing method of the present invention are conducted as on a real test track with either an open loop or closed loop driver. The test rig 12, working with the full vehicle model 26 applies loads to the axle system components in a manner that will be similar to the loads developed on a real road. The test rig 12 commands are not known in advance, so test rig iterative control techniques to develop modified load time histories may not be used. Metrics are defined to assess axle impact on ride, handling, comfort or other vehicle parameters. The test rig control is designed to produce minimum command tracking error. Inverse rig model and system identification techniques will achieve minimum tracking error.

FIGS. 1 and 2 depict only a single test rig 12 for testing axle systems. In other embodiments of the invention (not shown), other component test rigs, such as steering, traction simulation, etc., are linked to the axle system via the real-time model and supervisor to assess multiple mechanical and/or electronic and software systems in real time.

Referring to FIG. 2, the supervisor 14 is depicted as being provided by a second data processor 32, although the data processors 30 and 32 may be realized by a single data processor in certain embodiments. The software run by the data processor 32 coordinates the full vehicle model run by the data processor 30, the HIL (hardware in loop) system (if present) and the test rig 12. The system may provide an automation method/sequence that can vary vehicle, component control software, driver model, or maneuver definitions to find faults or search for local/global optimum settings as defined a list of target attributes. In certain embodiments, the full vehicle model 26 integrates with and simulates a vehicle electronics network. The axle or vehicle (electronic control units) ECUs may be included with or without HIL ECU test system to provide ECU vehicle parameters required to simulate in-vehicle operation.

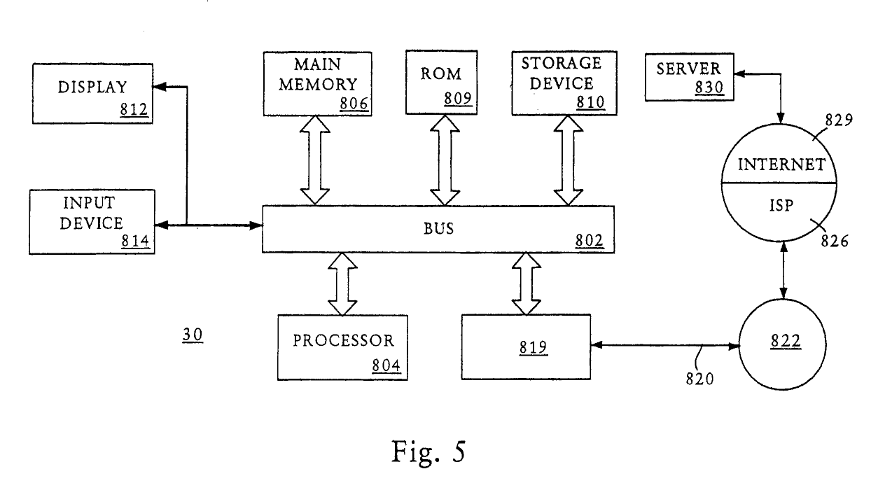

A more detailed description of an exemplary embodiment of a suitable data processor (30 or 32) is provided in FIG. 5, but FIG. 2 provides an overall view of the arrangement 10 and will be described. The simulation model 26 is run by the vehicle control module 18, which may be embodied, at least in part, by the data processor 30. In certain embodiments, the data processor 30 includes a plurality of modules for running the vehicle model. These include, for example, model optimization and mapping, customer simulation models, code generation, runtime tools and simulation visualization. The data processor performs real-time execution of simulation models, and includes a signal and communication interface.

The supervisor 14, embodied by the data processor 32, for example, also has a plurality of modules. These include rig system initialization, system setup, manual control, automated sequencing, subsystem management, system status, rig visualization, rig calibration, real-time degree of freedom control, data acquisition, signal management and safety management.

Data acquisition controller 34 acquires data signals from the test rig 12, and provides them to the data processor 32 of the supervisor 14. The data signals are produced by the load cells 52 and measuring device 58. The data is output by the supervisor 14 to the data processor 30 for use in the vehicle model 26.

An electronic control unit (ECU) 36 can be part of the evaluation process in certain embodiments, and be removed from the vehicle model 26, as is the case for the axle system 40. The ECU 36 under test may be part of an active axle system, for example, or some other system. Bus monitoring may be performed by a bus monitor 38.

Methods of the present invention reduce real-time test rig control lag, and compensate for test rig sensors as necessary. Sensor signals are communicated to the vehicle model with minimal lag to permit stable operation of the model. Data from the full vehicle model 26 can be captured and stored to serve as experimental results. Similarly, data from the axle components can be captured and stored to serve as experimental results.

FIG. 5 is a block diagram that illustrates an exemplary embodiment of the data processing system 30 upon which a real-time full vehicle simulation model 26 may be implemented by the vehicle model module 18. A similar data processing system may be employed for the data processing system comprising the supervisor 14. Data processing system 30 includes a bus 802 or other communication mechanism for communicating information, and a processor 804 coupled with bus 802 for processing information. Data processing system 30 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Data processing system 30 further includes a read only memory (ROM) 809 or other static storage device coupled to bus 802 for storing static information and instructions for processor 804. A storage device 810, such as a magnetic disk or optical disk, is provided and coupled to bus 802 for storing information and instructions. In certain embodiments, the data storage device 810 comprises the storage device 16.

Data processing system 30 may be coupled via bus 802 to a display 812, such as a cathode ray tube (CRT), for displaying information to an operator. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812.

The data processing system 30 is controlled in response to processor 804 executing one or more sequences of one or more instructions contained in main memory 806. Such instructions may be read into main memory 806 from another machine-readable medium, such as storage device 810 (16). Execution of the sequences of instructions contained in main memory 806 causes processor 804 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810 (16). Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 804 for execution. For example, the instructions may initially be carried on a magnetic disk of a remote data processing system. The remote data processing system can load the instructions into its dynamic memory and send the instructions over a telephone line using a modem, or by an other suitable form of communication. A modem local to data processing system 30 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 (16) either before or after execution by processor 804.

Data processing system 30 also includes a communication interface 819 coupled to bus 802. Communication interface 819 provides a two-way data communication coupling to a network link that is connected to a local network 822. For example, communication interface 819 may be an integrated services digital network (ISDN) card or a modem to provide a data communication connection to a corresponding type of telephone line. As another example, communication interface 819 may be a local area network (LAN) card to provide a data communication connection to a compatible LAN. Wireless links may also be implemented. In any such implementation, communication interface 819 sends and receives electrical, electromagnetic or optical signals that carry digital data streams representing various types of information.

The network link 820 typically provides data communication through one or more networks to other data devices. For example, the network link 820 may provide a connection through local network 822 to a host data processing system or to data equipment operated by an Internet Service Provider (ISP) 826. ISP 826 in turn provides data communication services through the world wide packet data communication network now commonly referred to as the “Internet” 829. Local network 822 and Internet 829 both use electrical, electromagnetic or optical signals that carry digital data streams. The signals through the various networks and the signals on network link 820 and through communication interface 819, which carry the digital data to and from data processing system 30, are exemplary forms of carrier waves transporting the information.

Data processing system 30 can send messages and receive data, including program code, through the network(s), network link 820 and communication interface 819. In the Internet example, a server 830 might transmit a requested code for an application program through Internet 829, ISP 826, local network 822 and communication interface 819.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

The embodiments of the present invention therefore provide improved methods and systems for axle system evaluation and tuning by employing a combination of a full vehicle model, a road description and a test rig with at least one physical axle system. Axle system evaluation can occur without the need to gather road data with a full vehicle, allowing earlier testing than otherwise possible. The axle system components can be characterized under conditions which represent those that would occur on a road, without the need for either a real vehicle or a real road. Since the axle system components interact with the vehicle model through test rig feedback, changes in the axle system characteristics will result in changes in applied load, as will happen on a real road, thereby resulting in more realistic testing. The embodiments of the invention do not require reduction of axle system characteristics to engineering terms of an implied axle model, since a real axle with all of its un-modeled characteristics interacts with the modeled vehicle as it would with a real vehicle.

Although embodiments of the present invention have been described and ed in detail, the same is by way of illustration and example only and is not to be way of limitation, the scope of the present invention being limited only by the the appended claims.

What is claimed is:

1. A system for evaluating axle systems and vehicle performance, comprising:
at least one test rig on which at least one axle system under test is mountable, the test rig controllably applying loads on the axle system under test; and
a vehicle model module that includes:
a data processor for processing data; and
a data storage device configured to store: data related to a vehicle model that simulates a full vehicle except for characteristics of the axle system under test; data related to a road description; driving instructions, human driver control, and machine-executable instructions, wherein the instructions, upon execution by the data processor, control the vehicle model module to produce command signals based on the vehicle model and the road description to control the test rig to apply loads on the axle system and to feed back measured responses of the test rig to the vehicle model.

2. The system of claim 1, further comprising a supervisor coupled to the vehicle model module and to the test rig, the supervisor comprising a data processor configured to coordinate the vehicle model and the test rig, provide the command signals to the test rig and provide the measured responses to the vehicle model.

3. The system of claim 1, wherein the human driver control component of the vehicle model is configured to operate open loop with respect to at least one of speed, course, position, behavior, or condition of the vehicle.

4. The system of claim 1, wherein the human driver control component of the vehicle model is configured to operate closed loop with respect to a speed and course of the vehicle.

5. The system of claim 1, wherein the full vehicle model includes modeling of: engine; powertrain, tires, vehicle dynamics, aerodynamics, driver and road.

6. The system of claim 5, wherein the full vehicle model includes models of axle systems that are not physically present in the test rig.

7. The system of claim 6, wherein the data processor is configure to model the full vehicle by a converging iterative process to virtually move the axle system under test to different positions on the vehicle model.

8. The system of claim 1, wherein the data related to the road description includes roadway surface definition including at least one of the parameters: coefficient of friction, roughness, slope, curvature, obstacle profiles, bump profiles and temperature.

9. The system of claim 1, wherein the test rig includes at least one loading actuator that is controllable to apply positions and angles to the axle system.

10. The system of claim 9, wherein the test rig includes a plurality of the loading actuators, wherein each loading actuator is independently controllable.

11. The system of claim 9, wherein the positions and angles include at least one of: body z, γ; road z(2), road α(2), road v(2), and steer wheel position.

12. The system of claim 1, wherein the test rig includes a moment input fixture controllable to input a moment on the axle component.

13. The system of claim 2, wherein the supervisor and the vehicle model module are configured for coupling to different component test rigs for other vehicle components to interact with the different component test rigs and integrating in the vehicle model results from the different component test rigs and the test rig on which the axle system under test is mounted.

14. A method of evaluating axle systems and predicting vehicle performance, comprising:
mounting at least one axle system on at least one test rig;
modeling a road environment, human driver and vehicle model that is a full vehicle model excluding the axle system on the test rig;
determining state and motion of the modeled vehicle model over a road;
generating command signals to the test rig based on the vehicle model and its state as at least one of displacement and load control signals;
applying at least one of displacements and loads to the axle system with the test rig in accordance with the command signals;
measuring at least one of resulting displacements or loads of the axle system at the test rig; and
providing at least one of measured complementary displacements or loads to the vehicle model.

15. The method of claim 14, wherein the vehicle model is executed in real time.

16. The method of claim 14, wherein the axle system loads are provided to the test rig substantially synchronously with the vehicle model.

17. The method of claim 15, wherein a plurality of physical axle systems of a vehicle are mounted on at least one test rig and simultaneously evaluated.

18. The method of claim 15, further comprising simultaneously controlling a plurality of test rigs on which axle systems are mounted.

19. The method of claim 15, further comprising controlling inputs to test rigs on which are mounted physical vehicle components other than axle systems, and receiving outputs from the test rigs and providing the outputs to the vehicle model.

20. The method of claim 15, further comprising subjecting the axle systems to environmental conditions.

21. The method of claim 15, wherein the step of applying at least one of displacements and loads to the axle system with the test rig includes axially loading the axle system with a loading actuator.

22. The method of claim 21, wherein the test rig includes a plurality of the loading actuators, wherein each loading actuator is independently controllable to axially load the respective axle system.

23. The method of claim 15, wherein the step of applying at least one of displacements and loads to the axle system with the test rig includes inputting a moment on the axle system with a moment input fixture.
